(19) United States
(12) Patent Application Publication
(10) Pub. No.: US 2026/0152091 A1
(43) Pub. Date: Jun. 4, 2026

(54) Apparatus for Monitoring Vehicle Systems and Location

(71) Applicant: Georgia Tech Research Corporation, Atlanta, GA (US)

(72) Inventors: Stephen Balakirsky, Atlanta, GA (US); Colin Usher, Atlanta, GA (US); Matthew Swarts, Alpharetta, GA (US)

(21) Appl. No.: 18/438,376

(22) Filed: Feb. 9, 2024

Related U.S. Application Data
(60) Provisional application No. 63/484,030, filed on Feb. 9, 2023.

(51) Int. Cl. B60L 58/16; B60L 53/66; B60L 53/68; G05D 1/656

(52) U.S. Cl. CPC B60L 58/16; B60L 53/66; B60L 53/68; G05D 1/656

(57) ABSTRACT

A vehicle monitoring device has terminals operably connected to a vehicle battery circuit via a connection port of a vehicle. A resistive load is also connected to the terminals. A computer is connected to the terminals and positioned to measure an open circuit voltage across the resistive load. The computer includes a processor and computer memory storing respective voltage measurements, and the respective voltage measurements correspond to available vehicle battery voltage.

### REFERENCE TO RELATED APPLICATIONS

This application claims priority to and incorporates by reference Provisional Patent Application Ser. No. 63/484,030 filed on Feb. 9, 2023, entitled “Vehicle Health and Location Monitor.”

### STATEMENT REGARDING GOVERNMENT SUPPORT

This invention was made with government support under W31P4Q18D0002-W31P4Q18F0090 awarded by United States Marine Corps. The government has certain rights in the invention.

### BACKGROUND OF THE DISCLOSURE

The military has a requirement to provide long-term storage of multiple classes of vehicles. These vehicles must be able to be deployed at a moment's notice. In practice, when an attempt is made to pull these vehicles out of storage and into active use, many problems arise. One common problem is an issue with the battery system of the vehicle. This prevents the vehicle from starting, delays the use of that particular vehicle, and due to the confined spaces of the warehouse, may block many other vehicles from being deployed. Other systems in the vehicle are also found defective if a vehicle has been unused for quite some time.

Also, the military must also closely track the location of these vehicles. Current tracking techniques rely on an RFID tag on the vehicle that is periodically scanned to confirm the vehicle's location. However, vehicles are often moved for routine maintenance or to allow access for maintenance on other assets. These vehicles are often not replaced in the same location from where they originated, thus creating errors in the vehicle location database.

A need in the art exists for systems, methods, and apparatuses that allow real time assessment of vehicle systems, including battery charge and battery health, as well as vehicle location.

### SUMMARY OF THE DISCLOSURE

In one embodiment, a vehicle monitoring device has terminals operably connected to a vehicle battery circuit via a connection port of a vehicle. A resistive load is also connected to the terminals. A computer is connected to the terminals and positioned to measure an open circuit voltage across the resistive load. The computer includes a processor and computer memory storing respective voltage measurements, and the respective voltage measurements correspond to available vehicle battery voltage.

In another embodiment, a vehicle monitoring system includes a plurality of vehicle monitoring devices operably connected to respective connection ports on a plurality of vehicles, wherein each of the vehicle monitoring devices has electronic access to a controller and a communications circuit. Respective controllers include software causing the vehicle monitoring devices to utilize respective communications circuits to form a communications network with the plurality of vehicle monitoring devices in data communication with each other. Data processing hardware connected to the network is used for sending and receiving vehicle data corresponding to each of the plurality of vehicle monitoring devices.

In another embodiment, a computer implemented method of monitoring vehicle battery health in a vehicle includes connecting a vehicle monitoring device to a vehicle battery circuit via a connection port of the vehicle; transmitting power from the vehicle battery across a resistive load connected to the vehicle monitoring device; measuring an open circuit voltage across the resistive load with a computer connected to the vehicle monitoring device; storing respective voltage measurements in the time domain in memory connected to the computer, and assessing vehicle battery voltage as an indication of vehicle battery health.

### BRIEF DESCRIPTION OF FIGURES

The components in the drawings are not necessarily to scale relative to each other. Like reference numerals designate corresponding parts throughout the several views.

FIG. 1 is a front view of an example vehicle having a connection port in the form of a NATO slave port as for receiving a battery charging unit in a military context.

FIG. 2 is a top perspective view of a vehicle monitoring device according to the implementations of this disclosure.

FIG. 3A is a top front view of a vehicle monitoring circuit board for installation within the vehicle monitoring device of this disclosure.

FIG. 3B is a top rear view of a vehicle monitoring circuit board for installation within the vehicle monitoring device of this disclosure.

FIG. 4 is a system architecture for using the vehicle monitoring device of this disclosure for data collection and data transmission according to this disclosure.

FIG. 5 is a flow chart of a method of monitoring a vehicle with the vehicle monitoring device of this disclosure.

FIG. 6A is a schematic representation of an RFID reader with synchronization hardware to allow for multiple readers to be used in a given area at the same time according to aspects of this disclosure.

FIG. 6B is a schematic representation of an RFID tag that can be attached to a vehicle and operate with the reader of FIG. 6A according to embodiments herein.

FIG. 7 is a schematic representation of an automated vehicle attendant, such as a remotely controlled or autonomous robot configured to communicate with the vehicle monitoring device of FIG. 3A in accordance with aspects of this disclosure.

FIG. 8 is a plot of voltage and ambient temperature output readings gathered for a vehicle with the vehicle monitoring device of this disclosure.

FIG. 9 is a plot of voltage output readings gathered for a vehicle with the vehicle monitoring device of this disclosure.

FIG. 10 is a plot of voltage and ambient temperature output readings gathered for a vehicle with the vehicle monitoring device of this disclosure.

FIG. 11 is a schematic representation of a computer environment used to implement the apparatus, system and method of this disclosure in example embodiments.

### DETAILED DESCRIPTION

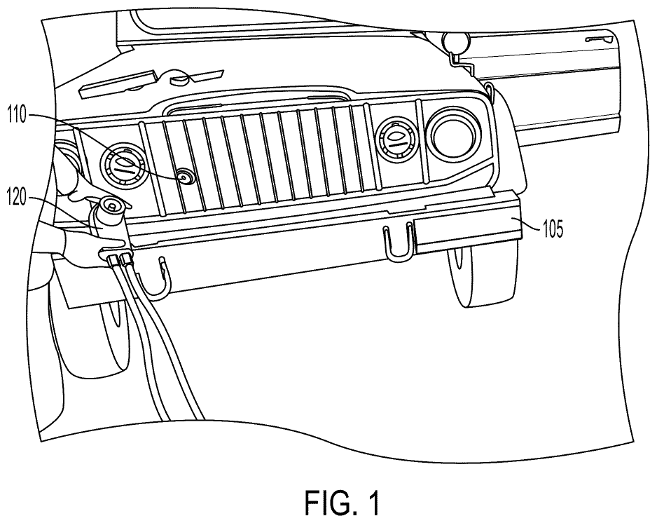

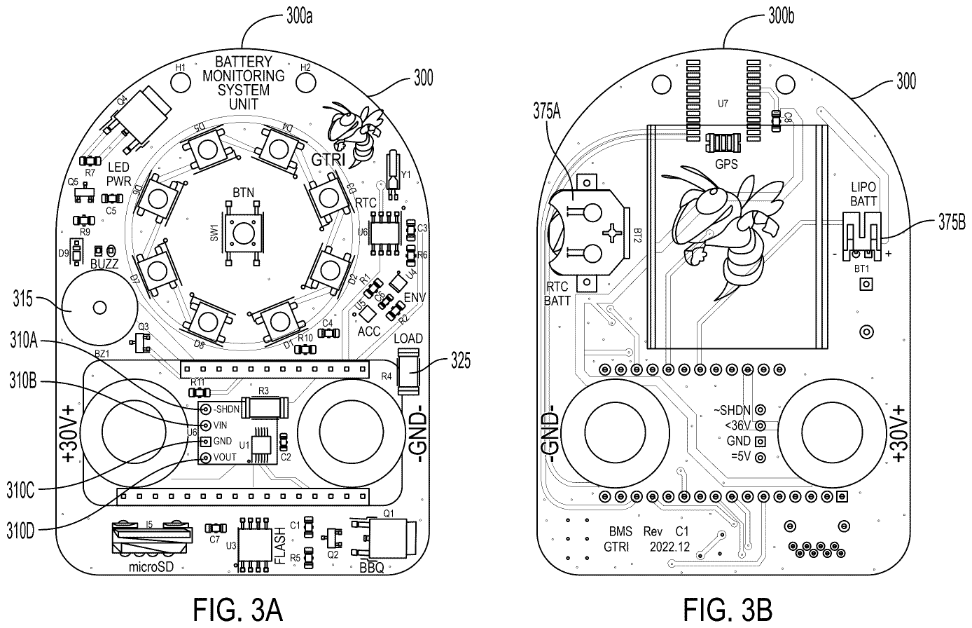

Every US combat vehicle 105 can contain a standard NATO Slave Port 110 which includes a fast connection to the vehicle battery for charging, as shown in FIG. 1. A corresponding power charging device 120 attaches to the slave port 110 by simply sliding into the slave port 110 and connecting to matching contacts, shown in this example as male and female circular contacts. The apparatus described herein may also be configured to fit into the slave port 110 and include all the functionality of traditional charging devices 120 with the added computer processing hardware shown in FIGS. 3A and 3B and software described herein. This disclosure is not limited to NATO slave ports, but similar devices and concepts disclosed herein may also be adapted for connecting the vehicle monitoring devices to on-board diagnostic ports in military and civilian vehicles.

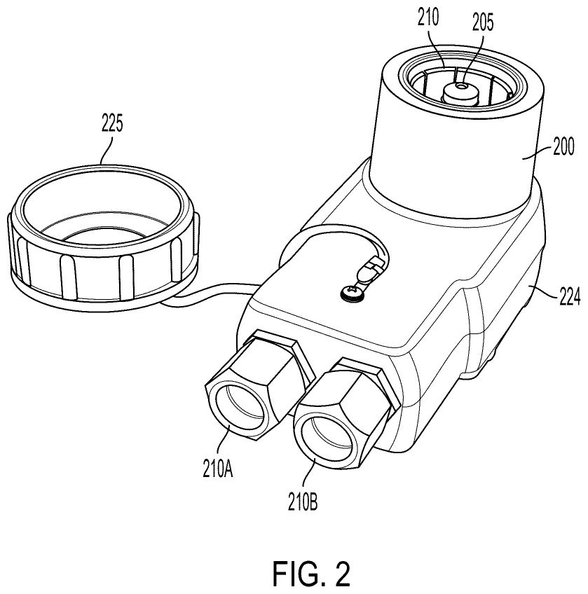

FIG. 2 shows one example of a vehicle monitoring device 200 of this disclosure. The outer housing 224 and cap 225 are similar to charging devices that can fit into NATO slave ports as shown in FIG. 1. The vehicle monitoring device 200 also includes cable connectors 210A, 210B for connecting to outside power sources to charge a vehicle battery via the positive male contact 205 and negative female contact 210.

FIG. 3 illustrates computer hardware and circuits on a circuit board having a front side 300A and a rear side 300B. The circuit board 300 is configured to be installed in the housing 224 of the vehicle monitoring device 200 shown in FIG. 2. FIG. 3A illustrates components including shutdown pin 310A, input voltage circuitry 310B, ground pin 310C, and output voltage pin 310D. The circuit board 300 can be powered by a vehicle battery circuit and measure the vehicle battery power by measuring an open circuit voltage across a resistive load 325. Other circuits on the circuit board 300 can be on a rear surface 300B such as a real time clock battery 375A and/or a rechargeable lithium polymer battery 375B. Other circuits are also included for RFID operations and wireless data network communications.

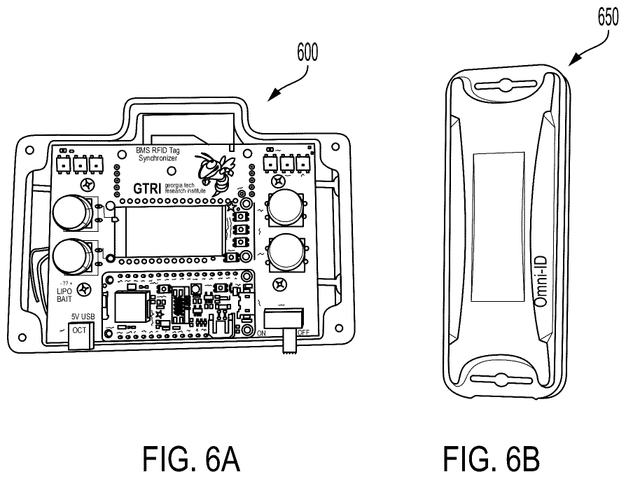

During preparation of a vehicle for storage, embodiments of the present disclosure include an RFID read and write interrogator 600 of FIG. 6A which can scan the vehicle's RFID tag, such as that of FIG. 6B at 650 to associate certain data in the tag with the vehicle monitoring device 2000 in order to associate the vehicle monitoring device 200 with the particular vehicle. The vehicle monitoring device 200 is then attached to the NATO Slave Port 110 and/or a vehicle onboard diagnostics port, where it may continuously monitor vehicle health.

Multiple vehicle monitoring devices are able to create a mesh network and localize themselves within that network. When a single vehicle monitoring device 200 is provided with a base reference location (for example, when being read by a mobile interrogator 600), all of the units are able to derive their geodetic coordinates. Items such as battery and vehicle health, along with vehicle location are continuously updated to the warehouse database.

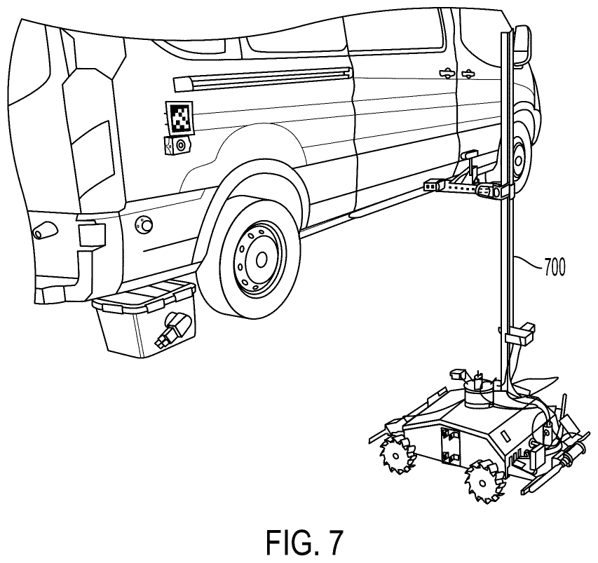

The example system can include a single board computer wired directly into a NATO Slave plug (typical plug shown in FIG. 1). Upon installation, a service technician can scan the target vehicle's RFID tag 650 and then plug the vehicle monitoring device 200 into the NATO slave port 110. The system of this embodiment can automatically attempt to establish connectivity with an example self-accumulating mesh network for communicating vehicle health information. When on routine patrol, a mobile robot 700 such as shown in FIG. 7 or human patrol can tap into this network to read the battery status, health status, and location of all connected vehicles.

The example vehicle monitoring device can be a part of an overall Battery Monitoring System (BMS) and can include a battery monitoring and alerting system for vehicles in storage. The BMS can connect to a standard auxiliary battery port, such as a cigarette lighter port on a commercial vehicle or a NATO slave port on a military system or an onboard diagnostic port available on a vehicle. The system embodiment may be composed of two devices. The first device is actually connected to the stored vehicle and consists of commercial components such as those shown in FIGS. 2-4 along with a custom-designed circuit board 300 as shown in FIGS. 3A and 3B. The second device may be a handheld reader 600 of FIG. 6 that is used to initialize the BMS and tie it to a specific vehicle. The mobile robot 700 can also be used to operate the reader component as desired.

The example BMS unit is designed to be installed on a vehicle (simply plugged in) and left for long periods of time. During use, it can optionally report any or all of the following:

Measure state of battery as battery voltage.

Report on the location of the vehicle.

Report on the time of a vehicle start and the duration of the run.

Optionally report an alert when a vehicle has been started.

Optionally report an alert when a vehicle is moved.

Update state of battery at least once per day, but at a user specified period that may be much more frequent.

Capture historical view of battery state over time (30 to 300 or more days).

Primary power from 12V/24V from vehicle.

Status of Secondary Power Source—i.e., lithium polymer rechargeable battery 375B.

Wireless notification when battery below a voltage threshold.

Visual notification available through LED lights.

Auditory notification may be available through a buzzer 315.

Haptic notification may be provided through the handheld reader.

Verbal notification may be provided through a speaker.

The network may be able to accommodate a minimum of 200 units.

The network may dynamically configure and may be able to auto-reconfigure within 1 hour (or less).

The system may have NFC capabilities to replace the RFID.

Units may be able to communicate with other units within 30m to establish a mesh network.

Units may be able to localize themselves within the mesh.

The entire mesh may be anchored to the ground via a single unit with a known location.

Indoor localization may be within <10 m.

Optional GPS/GNSS module may provide outdoor localization.

Optional cellular module (e.g., 4G or 5G) may provide both wireless connectivity to the network for information reporting as well as localization information

Optional satellite module may provide both wireless connectivity to the network for information reporting as well as localization information.

The unit can implement a geo-fence functionality such that it stops reporting vehicle location when outside of a prescribed location.

The vehicle monitoring device 200 can log all information locally on the unit.

The vehicle monitoring device 200 transmits its information to a central logging station via one or more modalities that include Bluetooth, WiFi, cellular, or satellite communications.

### Handheld Reader Capabilities

The handheld reader 600 is designed to capture vehicle identification information, such as a national stock number of VIN, and send this information into the vehicle monitoring device so that each vehicle monitoring device is associated with a specific vehicle. In addition, the handheld reader is able to help a user locate a particular vehicle monitoring device in a large lot.

Able to read vehicle RFID information and then transmit to the vehicle monitoring device 200.

Able to use camera and optical character recognition to read VIN or serial number information from vehicle identity plates and transmit to the vehicle monitoring device 200.

Able to use camera and optical character recognition to read military ID painted onto vehicle exterior and transmit to the vehicle monitoring device 200.

User is able to specify a vehicle in a large lot to find. Handheld reader can provide tracking directions to vehicle and notify the user of vehicle proximity via haptic, audio, and/or visual feedback.

### Communication Techniques

Optionally, the vehicle monitoring device can communicate information via Bluetooth to a central logging node which may be a base unit version of a vehicle monitoring device 200. When logging via Bluetooth, Bluetooth Low Energy beacon or mesh techniques can be utilized.

### Bluetooth Low Energy Beacon (BLE)

Optionally, embodiments of the present disclosure can include a BLE Beacon. The BLE beacon can include a universally unique identifier (UUID) and a custom data payload (e.g., about 39 bytes). Optionally, this is connection-less, and any Bluetooth receiver (e.g. a phone) can receive these. Alternatively or additionally, embodiments of the present disclosure can include built-in basic encryption, for example, a cipher. Beacons are typically emitted at 1-10 Hz and across three specific channels in the BLE spectrum.

### BLE Mesh

The BLE mesh can optionally use a flooding algorithm. As the network of devices increases, the flooding algorithm becomes less efficient, and latency increases. Bluetooth 4.x can only subscribe to messages in the mesh and cannot publish like with Bluetooth 5.x.

Bluetooth mesh networking technology allows you to connect more than 30 thousand devices at once.

### Custom BLE Mesh

### Paired Bluetooth BR/EDR

Bluetooth Basic Rate/Enhanced Data Rate. This uses more power and often requires pairing to a host device. There is already a specification that exists for a Bluetooth Battery Service Specification.

The Battery Level characteristic is read using the GATT Read Characteristic Value sub-procedure and returns the current battery level as a percentage from 0% to 100%; 0% represents a battery that is fully discharged, and 100% represents a battery that is fully charged.

Optionally, the communication can be implemented using a Zigbee (2.4 GHz) including routing.

LoRa (long range communications) (915 MHz or other ISM band) can have multi-path issues inside a warehouse where low frequencies (<1 GHz) go far (several miles) and can bounce around a lot in a warehouse.

Alternatively or additionally, cellular can be used (various, not ISM).

Optionally, IoT SIM Cards or e-SIM numbers can be used, including an account. Carrier may be employed to support the cellular chipset.

Satellite (various, not ISM) can be used in some embodiments of the present disclosure. Starlink is a satellite carrier, but the antenna required is too large, consumes too much power, and needs to be stationary.

In some embodiments, the system may be used with Starlink or other satellite systems. Optionally, the “emitter” doesn't have to be on the individual vehicles, and it could be in a central location and collects data from the vehicles and then transmits.

Additional non-limiting examples include the NAL SHOUT sp is an Iridium-based satellite phone; optionally, the Iridium 9602 Module can be used by itself.

### Security

Embodiments of the present disclosure can optionally include Advanced Encryption Standard (AES) encryption of messages over the air. If there is a database, that can be encrypted as well.

### Other Communication

Embodiments of the present disclosure can further include additional user interface components. LED indicator lights for status of connections or of the battery state or health.

Alternatively or additionally, LCD, OLED, e-Ink, or 7-segment displays can be used to show or cycle through critical data such as the battery voltage. Optionally, the display can be operated part- or all of the time, except for an e-Ink one. Optionally, presence detection can be included to automatically illuminate when there is someone nearby to view the voltage so they don't have to press any buttons to activate the display. Presence detection can be with wireless signal detection, infrared motion, or even ultrasonic movement.

Speakers or buzzers to announce settings or give acoustic pings or chirp as feedback when the battery is low are options for the vehicle monitoring device 200. This would be a backup to check a screen interface somewhere else.

### Data Storage

Ideally, the vehicle monitoring device would have EEPROM for configuration storage, but FLASH storage is also an available option. These configurations would be for the unique ID, RFID, mesh network settings, and other settings related to sampling frequency and duty cycle timing.

For some mesh networks that use routing tables, the processor needs enough SRAM to be able to temporarily store those large routing tables. Depending on the network size, this routing table could become very large.

Some embodiments of the present disclosure can implement the ability for each unit in the mesh to store salient data from all units in the network. This can be useful if there were not a gateway up 100% of the time. Then when a gateway does connect, it can pull the latest data of all vehicle monitoring devices through the nearest node in the mesh. This would especially be useful if the data sampling and publishing to the network have a very low duty cycle, eg once a day.

### Power

Optionally, the BMS can have a secondary rechargeable battery. This secondary battery should have enough capacity to last at least a day if not 1-4 weeks without recharge. This is very do-able with a low power mode. The main power should come from the vehicle battery itself. Efficiently converting 12V/24V down to usable embedded systems voltage (e.g. 1.8V-3.3V-5.0V) is difficult. Switch mode regulation is more efficient with higher current draws than a linear voltage regulator, but at low current draws it is not as efficient. Optionally, the quiescent current of the voltage regulation can be more than the vehicle monitoring device 200 itself actually consumes, and potentially would thwart attempts at making a low power system. By having a secondary battery, embodiments of the present disclosure can use it as a ‘quiescent buffer’. There are some low quiescent charging chips that are efficient and follow the correct charging profile for the specific battery chemistry. Then the low power draw by the BMS on the secondary battery can be very efficient and can only need a basic LDO with a very low voltage drop, resulting in good conversion.

### Vehicle Recharging

The vehicle monitoring device is designed to interface with a mobile robot for trickle-charging vehicles with low battery levels. The vehicle monitoring device can be connected to a movable target that is placed at the correct height for the mobile robot. The mobile robot is then able to connect to this target, enable relays that create a charging circuit through the vehicle monitoring device 200 to the vehicle battery, and safely charge the vehicle system.

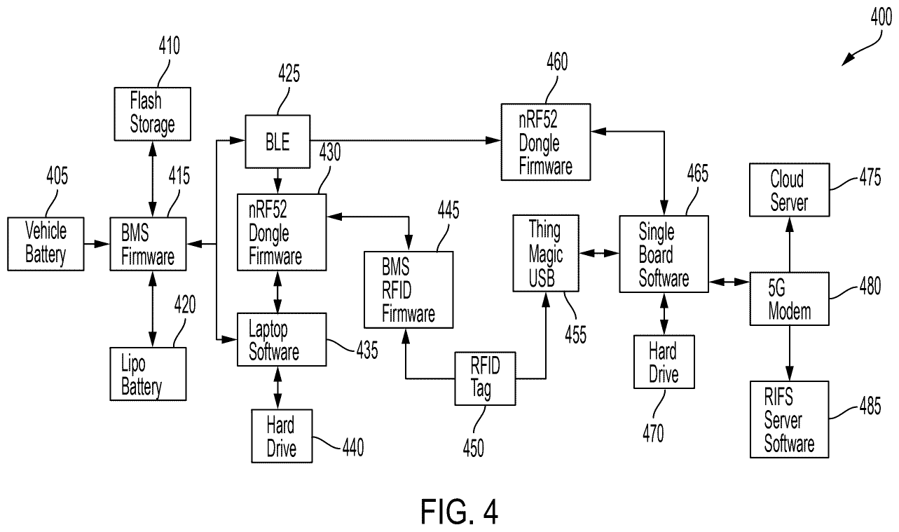

An example system architecture to accomplish the above-described functions has been designed as shown in FIG. 4, below. The example system architecture can include any combination of the devices and systems described herein. Considering FIG. 4 as a flowchart of sorts, the vehicle battery 405 is connected to the vehicle monitoring device 200 and the circuit board 300 in the form of a battery monitoring system (BMS) having firmware 415. As the vehicle battery 405 discharges, the BMS reads an open circuit voltage across a resistive load 325 to monitor the power available in the vehicle battery 405. The data collected can be saved in FLASH storage 410, having ability to save, transmit, and erase the battery health data or other peripheral or derived information about the vehicle. The BMS having a connection to the vehicle battery, as described above, can use a rechargeable battery 375 at block 420 as a quiescent buffer to control the current on the BMS during idle periods, as described above. In this way, blocks 405, 410, 415, and 420 can be considered the overall BMS system with FLASH download options set forth in the dongle firmware 430, the laptop software 435, and a remote hard drive 440. The FLASH download options are tied into the Bluetooth Low Energy hardware 425 connected to the BMS and further connected to the functionality for the RFID operations utilizing appropriate connections for the RFID firmware 445, the RFID tag communications circuits 450 connected over USB to memory 465 and dongle firmware 460. Other components of the system architecture of FIG. 4 implement the vehicle battery voltage live capture and storage operations. These components include the circuitry used to measure the open circuit voltage and transmit the readings to the dongle firmware 460, memory on the circuit board at 465, connections to a remote hard drive 470, and transmission capabilities over the 5G modem 480 to a cloud server 475. Other combinations of components 460, 465, and 480 work with a reduced interframe space (RIFS) server software 485 for additional integration.

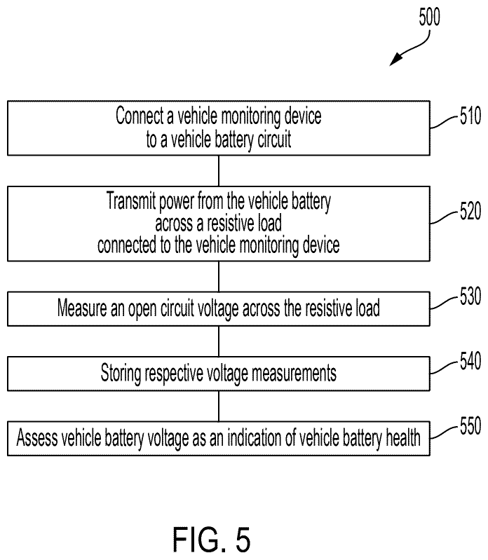

All aspects of the apparatus embodiment are amenable to be described as computer implemented methods that may be incorporated into a computer program product. FIG. 5 illustrates one such method. A computer implemented method 500 of monitoring vehicle battery health in a vehicle includes connecting a vehicle monitoring device to a vehicle battery circuit 510 via a connection port of the vehicle; transmitting power from the vehicle battery across a resistive load connected to the vehicle monitoring device 520; measuring an open circuit voltage across the resistive load 530 with a computer connected to the vehicle monitoring device; storing respective voltage measurements 540 in the time domain in memory connected to the computer, and assessing vehicle battery voltage as an indication of vehicle battery health 550.

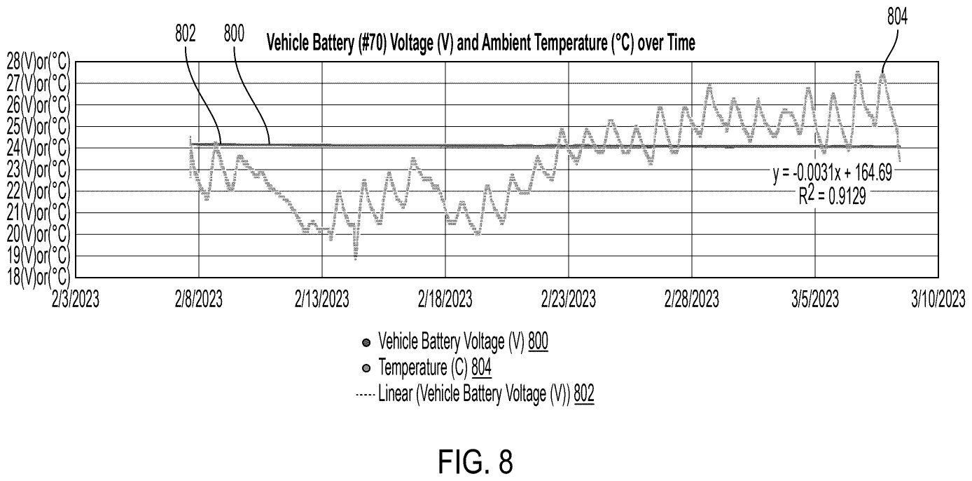

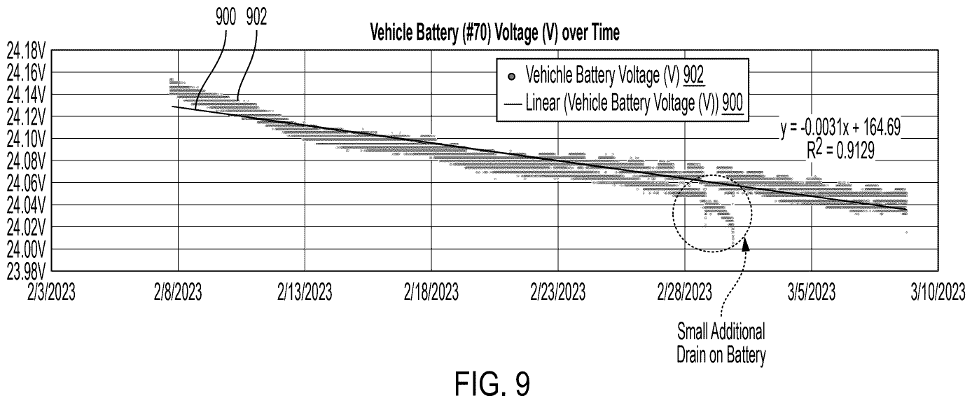

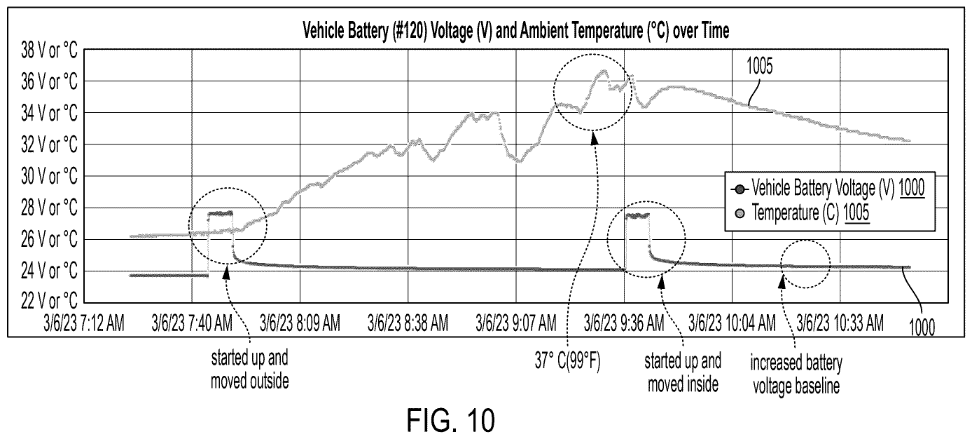

Implementing the methods of this disclosure allows for test results shown in FIGS. 8-10, showing voltage measurements from a vehicle battery for various ambient temperatures. FIG. 8 illustrates the vehicle battery voltage 800, the linear battery voltage 802, and the temperature 804. FIG. 9 shows vehicle battery voltage 900, the linear battery voltage 902 and illustrates an additional drain on the battery from another vehicle system. FIG. 10 illustrates the vehicle battery voltage 1000 and the temperature 1004 including episodes where the vehicle was started and moved into different environments with different temperatures.

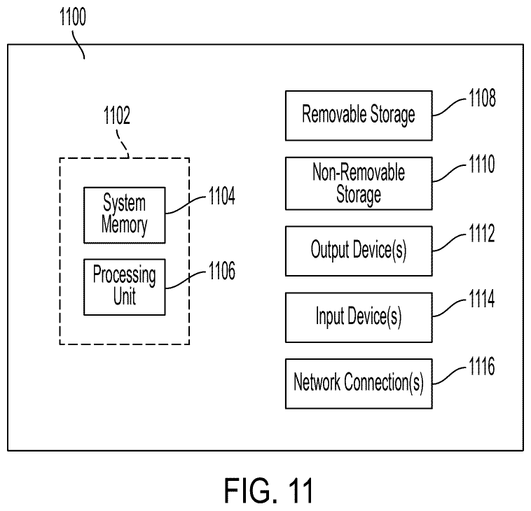

Referring to FIG. 11, an example computing device 1100 upon which the methods described herein may be implemented is illustrated. It should be understood that the example computing device 1100 is only one example of a suitable computing environment upon which the methods described herein may be implemented. Optionally, the computing device 1100 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 1100 typically includes at least one processing unit 1106 and system memory 1104. Depending on the exact configuration and type of computing device, system memory 1104 may be volatile (such as random access memory (RAM)), non-volatile (such as read-only memory (ROM), flash memory, etc.), or some combination of the two. This most basic configuration is illustrated in FIG. 11 by line 1102. The processing unit 1106 may be a standard programmable processor that performs arithmetic and logic operations necessary for the operation of the computing device 1100. The computing device 1100 may also include a bus or other communication mechanism for communicating information among various components of the computing device 1100.

Computing device 1100 may have additional features/functionality. For example, computing device 1100 may include additional storage such as removable storage 1108 and non-removable storage 1110, including, but not limited to, magnetic or optical disks or tapes. Computing device 1100 may also contain network connection(s) 1116 that allow the device to communicate with other devices. Computing device 1100 may also have input device(s) 1114 such as a keyboard, mouse, touch screen, etc. Output device(s) 1112, such as a display, speakers, printer, etc., may also be included. The additional devices may be connected to the bus in order to facilitate the communication of data among the components of the computing device 1100. All these devices are well-known in the art and need not be discussed at length here.

The processing unit 1106 may be configured to execute program code encoded in tangible, computer-readable media. Tangible, computer-readable media refers to any media that is capable of providing data that causes the computing device 1100 (i.e., a machine) to operate in a particular fashion. Various computer-readable media may be utilized to provide instructions to the processing unit 1106 for execution. Example of tangible, computer-readable media may include, but is not limited to, volatile media, non-volatile media, removable media, and non-removable media implemented in any method or technology for storage of information such as computer-readable instructions, data structures, program modules or other data. System memory 1104, removable storage 1108, and non-removable storage 1110 are all examples of tangible, computer storage media. Examples of tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 1106 may execute program code stored in the system memory 1104. For example, the bus may carry data to the system memory 1104, from which the processing unit 1106 receives and executes instructions. The data received by the system memory 1104 may optionally be stored on the removable storage 1108 or the non-removable storage 1110 before or after execution by the processing unit 1106.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language, and it may be combined with hardware implementations.

A vehicle monitoring device includes terminals operably connected to a vehicle battery circuit via a connection port of a vehicle and a resistive load connected to the terminals. A computer is connected to the terminals and positioned to measure an open circuit voltage across the resistive load, wherein the computer comprises a processor and computer memory storing respective voltage measurements, and wherein the respective voltage measurements correspond to available vehicle battery voltage. The connection port may be a slave port of the vehicle or an on-board diagnostics port of the vehicle. The slave port may be a standardized North American Treaty Organization (NATO) slave port. The vehicle monitoring device further includes a clock connected to the computer to store the respective voltage measurements in the time domain. A secondary power source may also be installed for connecting the terminals to the resistive load and connected to the computer for back-up power. A voltage regulator may be connected between the secondary power source and the resistive load. In some embodiments, the voltage regulator is a linear voltage regulator. The linear voltage regulator may be a linear and low drop out (LDO) regulator. The vehicle monitoring device may also include a communications circuit, connected to the computer, and configured to transmit the respective voltage measurements over a network. The communications circuit is further configured to receive control data for storage in the computer memory. The communications circuit within or connected to the vehicle monitoring device may include a wireless communications circuit that includes a transceiver connected to the computer. The network may be a mesh network connecting the transceiver to other vehicle monitoring devices having respective transceivers within an operable communication distance of the transceiver. The control data received and stored on or within the vehicle communications device may be RFID data, sensor data from other vehicle sensors, or additional data from environmental sensors. The RFID data may be vehicle identification information. The sensor data may be at least one of GPS data from a GPS device associated with the vehicle, image data, speedometer data, gyroscope data, vehicle ignition data, inertial measurement data, temperature data for vehicle components, smoke detection data, or vehicle diagnostic data. This data may be transmitted to the vehicle monitoring device from sensors connected to the vehicle or within an environment around the vehicle. The additional data from environmental sensors may be temperature data, humidity data, and precipitation data stored in the computer memory in the time domain.

In some embodiments of the vehicle monitoring device may include a charging auxiliary device, such as but not limited to the charging connections 210A, 210B of FIG. 2 and connected to the electrical connection assembly, and that is accessible from an exterior of the vehicle monitoring device to charge a vehicle battery in the vehicle battery circuit. In some embodiments, the charging auxiliary device and the vehicle battery are configured for trickle charging from an external power source connected to the charging auxiliary device 210A, 210B. The vehicle monitoring device may further include status indicators connected to the computer, wherein the status indicators comprise at least one device selected from visual feedback indicators, audible alarms, or haptic alarms connected to the vehicle monitoring device 200.

In another embodiment, a vehicle monitoring system may include a plurality of vehicle monitoring devices operably connected to respective connection ports on a plurality of vehicles, wherein each of the vehicle monitoring devices has electronic access to a controller and a communications circuit, wherein respective controllers have software causing the vehicle monitoring devices to utilize respective communications circuits to form a communications network with the plurality of vehicle monitoring devices in data communication with each other; and data processing hardware connected to the network for sending and receiving vehicle data corresponding to each of the plurality of vehicle monitoring devices. The vehicle monitoring system may include terminals operably connected to a vehicle battery circuit via a connection port of a respective vehicle, a resistive load connected to the terminals, a computer connected to the terminals and positioned to measure an open circuit voltage across the resistive load, and the computer may include a processor and computer memory storing respective voltage measurements, and respective voltage measurements correspond to available vehicle battery voltage. The vehicle monitoring system may be connected over a wireless mesh network, a cellular network, an RFID network, an NFC network, a Bluetooth network, a Bluetooth Low Energy network, a satellite communications network, or a WiFi network.

The system may include a mobile data processing unit, such as an RFID interrogator 600 that includes a camera and a corresponding communications processor for reading a vehicle identification number on each of the respective vehicles and downloading the VIN to a respective vehicle monitoring device to initiate the vehicle monitoring device for one of the respective vehicles. An automated mobile robot may include hardware placing the robot in data communication with the communications network, wherein the automated mobile robot is configured to communicate with each of the vehicle monitoring devices individually, locate the vehicle monitoring devices and identify a particular vehicle associated with a respective vehicle monitoring device. The robot is configured to navigate to the respective vehicle monitoring device. The vehicle monitoring system of claim 30, wherein the robot is configured to navigate to any vehicle with battery health below a threshold voltage value and charge the vehicle. The data processing hardware comprises a processor executing software that analyzes the vehicle data for patterns in the fleet of vehicles. The software includes computerized methods to perform analysis steps for vehicle battery health with voltage measurements from each vehicle in the fleet of vehicles. The analysis steps comprise cyclical voltammetry analyses, impedance spectroscopy for battery circuits, and frequency of full discharge of vehicle batteries. Additional sensors may be in data communication with the communications circuit of a respective vehicle monitoring device. The additional sensors may include a battery current draw monitor measuring current in a vehicle battery circuit. The battery current draw monitor measures magnetic flux generated by current from the vehicle battery on the vehicle battery circuit during phases of vehicle operation. The phases of vehicle operation comprise glow plug heating, ignition starting, and vehicle running. The battery current draw monitor is attached to a battery cable in a battery compartment of a vehicle. The data processing hardware receives current data from the battery current draw monitor over the communication network to identify parasitic current draw on a respective vehicle when the vehicle is in a power off state.

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. While implementations will be described for steering wheel hand detection systems, it will become evident to those skilled in the art that the implementations are not limited thereto.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the sensing system for a steering wheel as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting or layering arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present embodiments.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The embodiments of the method, system and computer program product described herein are further set forth in the claims below.

1. A vehicle monitoring device, comprising:
terminals operably connected to a vehicle battery circuit via a connection port of a vehicle;
a resistive load connected to the terminals;
a computer connected to the terminals and positioned to measure an open circuit voltage across the resistive load,
wherein the computer comprises a processor and computer memory storing respective voltage measurements from the open circuit voltage;
wherein the respective voltage measurements correspond to available vehicle battery voltage.

2. The vehicle monitoring device of claim 1, wherein the connection port comprises a slave port of the vehicle or an on-board diagnostics port of the vehicle.

3. The vehicle monitoring device of claim 2, wherein the slave port comprises a standardized North American Treaty Organization (NATO) slave port.

4. (canceled)

5. The vehicle monitoring device of claim 1, further comprising a secondary power source connecting the terminals to the resistive load and connected to the computer for back-up power.

6. The vehicle monitoring device of claim 5, further comprising a voltage regulator connected between the secondary power source and the resistive load.

7. (canceled)

8. The vehicle monitoring device of claim 6, wherein the voltage regulator is a linear and low drop out (LDO) regulator.

9. The vehicle monitoring device of claim 1, further comprising a communications circuit, connected to the computer, and configured to transmit the respective voltage measurements over a network.

10.-11. (canceled)

12. The vehicle monitoring device of claim 9, wherein the network comprises a mesh network connecting the transceiver to other vehicle monitoring devices having respective transceivers within an operable communication distance of the transceiver.

13. The vehicle monitoring device of claim 12, wherein the control data comprises RFID data, sensor data from other vehicle sensors, or additional data from environmental sensors.

14. The vehicle monitoring device of claim 13, wherein the RFID data comprises vehicle identification information.

15. The vehicle monitoring device of claim 13, wherein the sensor data comprises at least one of GPS data from a GPS device associated with the vehicle, image data, speedometer data, gyroscope data, vehicle ignition data, inertial measurement data, temperature data for vehicle components, smoke detection data, or vehicle diagnostic data.

16. (canceled)

17. The vehicle monitoring device of claim 1, further comprising a charging auxiliary device, connected to the electrical connection assembly, and that is accessible from an exterior of the vehicle monitoring device to charge a vehicle battery in the vehicle battery circuit.

18.-19. (canceled)

20. A vehicle monitoring system comprising:
a plurality of vehicle monitoring devices operably connected to respective connection ports on a plurality of vehicles, wherein each of the vehicle monitoring devices has electronic access to a controller and a communications circuit,
wherein respective controllers comprise software causing the vehicle monitoring devices to utilize respective communications circuits to form a communications network with the plurality of vehicle monitoring devices in data communication with each other; and
data processing hardware connected to the network for sending and receiving vehicle data corresponding to each of the plurality of vehicle monitoring devices.

21. The vehicle monitoring system of claim 20, wherein the vehicle monitoring devices comprise:
terminals operably connected to a vehicle battery circuit via a connection port of a respective vehicle;
a resistive load connected to the terminals;
a computer connected to the terminals and positioned to measure an open circuit voltage across the resistive load,
wherein the computer comprises a processor and computer memory storing respective voltage measurements from the open circuit voltage; and
wherein the respective voltage measurements correspond to available vehicle battery voltage.

22. The vehicle monitoring system of claim 20, wherein the communications network comprises a wireless mesh network, a cellular network, an RFID network, an NFC network, a Bluetooth network, a Bluetooth Low Energy network, a satellite communications network, or a WiFi network.

23.-24. (canceled)

25. The vehicle monitoring system of claim 20, further comprising a mobile data processing unit comprising a camera and a corresponding communications processor for reading a vehicle identification number on each of the respective vehicles and downloading the VIN to a respective vehicle monitoring device to initiate the vehicle monitoring device for one of the respective vehicles.

26. The vehicle monitoring system of claim 20, further comprising an automated mobile robot comprising hardware placing the robot in data communication with the communications network, wherein the automated mobile robot is configured to communicate with each of the vehicle monitoring devices individually, locate the vehicle monitoring devices and identify a particular vehicle associated with a respective vehicle monitoring device.

27. The vehicle monitoring system of claim 26, wherein the robot is configured to navigate to the respective vehicle monitoring device.

28.-29. (canceled)

30. The vehicle monitoring system of claim 25, wherein the vehicle data transmitted over the communications network comprises voltage data indicative of battery health of a respective vehicle.

31. The vehicle monitoring system of claim 30, wherein the robot is configured to navigate to any vehicle with battery health below a threshold voltage value and charge the vehicle.

32.-38. (canceled)

39. The vehicle monitoring system of claim 20, wherein the data processing hardware receives and stores the vehicle data for each vehicle in a fleet of vehicles, and wherein the data processing hardware comprises a processor executing software that analyzes the vehicle data for patterns in the fleet of vehicles.

40. (canceled)

41. The vehicle monitoring system of claim 39, wherein the software comprises computerized methods to perform analysis steps for vehicle battery health with voltage measurements from each vehicle in the fleet of vehicles, and wherein the analysis steps comprise cyclical voltammetry analyses, impedance spectroscopy for battery circuits, and frequency of full discharge of vehicle batteries.

42. (canceled)

43. The vehicle monitoring system of claim 20, further comprising additional sensors in data communication with the communications circuit of a respective vehicle monitoring device, wherein the additional sensors comprise a battery current draw monitor measuring current in a vehicle battery circuit.

44. The vehicle monitoring system of claim 43, wherein the battery current draw monitor measures magnetic flux generated by current from the vehicle battery on the vehicle battery circuit during phases of vehicle operation.

45. The vehicle monitoring system of claim 44, wherein the phases of vehicle operation comprise glow plug heating, ignition starting, and vehicle running, and wherein the battery current draw monitor is attached to a battery cable in a battery compartment of a vehicle, and wherein the data processing hardware receives current data from the battery current draw monitor over the communication network to identify parasitic current draw on a respective vehicle when the vehicle is in a power off state.

46.-51. (canceled)
